(19) United States
(12) Patent Application Publication
(10) Pub. No.: US 2008/0023408 A1
(43) Pub. Date: Jan. 31, 2008

(54) CATCH BASIN INSERT FOR TREATING STORM WATER

(75) Inventor: Harmon Rex Hansen, Vancouver, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Vanson Halosource, Inc., Redmond, WA (US)

(21) Appl. No.: 11/622,984

(22) Filed: Jan. 12, 2007

Related U.S. Application Data
(60) Provisional application No. 60/758,679, filed on Jan. 13, 2006.

(51) Int. Cl. C02F 1/52; B01D 21/01; C02F 1/54; C02F 1/56; E03F 5/16

(52) U.S. Cl. 210/705; 210/163; 210/164; 210/170.03; 210/198.1; 210/704

(57) ABSTRACT

A catch basin has a catch basin insert containing a water-soluble water treatment additive. The insert is made from a porous shell, which is segmented into individual pouches. Each pouch has an opening that can be opened and closed repeatedly to re-fill the water treatment additive. Adjacent pouches are separated by a strip of insert material to permit cutting the insert to a desired length. The water-soluble water treatment additive can be chitosan. Water treated with the additive is flocculated and removed in a filter.

### CROSS-REFERENCE TO RELATED APPLICATION

This application claims the benefit of Provisional Application No. 60/758,679, filed Jan. 13, 2006, the disclosure of which is hereby expressly incorporated by reference.

### BACKGROUND

Storm water which runs off land cleared of vegetation, such as from roads, parking lots, construction sites, and other developed sites, typically exhibits a high degree of contamination due to the presence of suspended sediment, metals, oil, and other chemicals and particulate matter. Stringent water quality standards, enforced under the Clean Water Act, have created the need to purify contaminated storm water. In addition, many cities and states have environmental regulations that require municipalities and developers to utilize Best Management Practices to meet water quality standards. These regulations mandate that contaminated water must be collected and treated to reduce contamination before discharge into the environment, such as into streams and vegetated areas.

Catch basin insert devices are known in the art and are used in conjunction with standard catch basins. These devices are typically made of filter mesh (metal or fabric) and a frame. Their function is to physically capture trash and debris before it enters the sump or outlet of the catch basin. When the devices are employed, all water that is to be treated must be filtered through the mesh. Over time or during major storm events, leaves and debris accumulate in the filter, thus causing premature clogging. Conventional drain systems lack adequate means to remove contaminants that are too small to be captured by the filters, such as bacteria and nutrients from storm water.

### SUMMARY

A system, method, and apparatus for removing a contaminant from storm water are described. Embodiments of a catch basin insert include a system, method, and apparatus for dosing a water treatment additive, such as chitosan, into storm water. The insert may be used in conjunction with another downstream collection and/or filtering device. By dosing a water-treatment additive, such as chitosan, into storm water, a high rate of removal efficiency is achieved. A system for removing a contaminant from storm water includes a catch basin for receiving storm water and a catch basin insert positioned in the catch basin in the path of storm water entering the catch basin. The insert includes a water-soluble water treatment additive contained within a porous shell. The insert is positioned at a height above which the level of storm water does not rise to prevent or minimize the treatment additive from dissolving. The system further includes a filter positioned downstream from the insert for filtering a contaminant flocculated by interaction with the water-soluble water treatment additive. Thus, the contaminant is removed from the storm water.

In another aspect, a method for flocculating a contaminant in storm water includes contacting storm water with an insert within a catch basin. The insert includes a water-soluble water treatment additive contained within a porous shell. According to this method, the insert is positioned in the catch basin in the path of storm water entering the catch basin and at a height above which the level of storm water does not rise in the catch basin. When storm water contacts the insert, a dose of the water-soluble water treatment additive is dissolved in the storm water and binds to a contaminant in the storm water to provide flocculated contaminant.

In another aspect, an insert for removing a contaminant from storm water is provided. The insert comprises a porous, elongate shell having a plurality of segmented pouches along the length of the shell. At least one pouch contains a water-soluble water treatment additive. Two or more adjacent pouches are separated by a strip of shell material to permit cutting the shell between pouches into a desired length without releasing the water-soluble water treatment additive from the pouches. In this embodiment, the strip of shell material may be bordered by two lines of stitching to separate the two adjacent pouches and leave a space between the lines of stitching where the insert may be cut. Alternatively, the stitching may be replaced with an adhesive or any other bonding method. In one embodiment, each pouch contains an opening closed by a resealable hook and loop fastener.

A preferred water-soluble water treatment additive contains chitosan. The insert may comprise chitosan, a chitosan salt, and other additives or fillers.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatical illustration of a flow diagram of a system and method for removing a contaminant from storm water;

FIG. 2 is a diagrammatical illustration of a side, cross-sectional view of a catch basin with a catch basin insert;

FIG. 3 is a diagrammatical illustration of a perspective view of a catch basin insert;

FIG. 4 is diagrammatical illustration of an exploded, perspective view of a catch basin with a catch basin insert; and

FIG. 5 is diagrammatical illustration of a side view of an embodiment of the catch basin insert.

### DETAILED DESCRIPTION

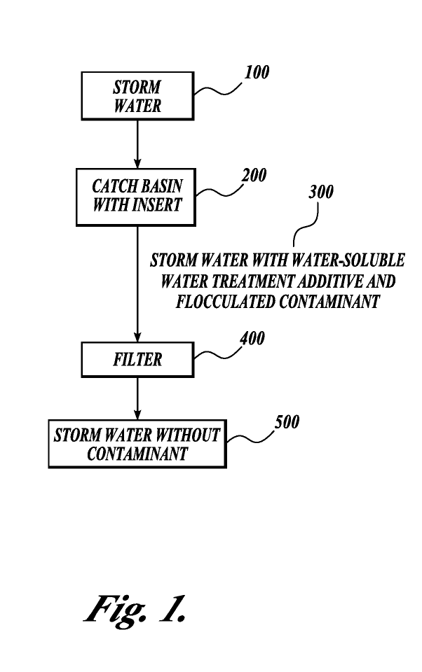

FIG. 1 is a flow diagram of a system and method for removing a contaminant from storm water. Storm water 100 is a general term to denote water originating from a range of sources that runs off surfaces. As non-limiting examples, storm water includes rainfall and snowfall run-off from roofs, roads, parking lots, other paved areas, construction sites, yards and other surfaces, and run-off from human activities, such as washing cars, overwatering lawns, spills or leaks, and irrigation. Thus, storm water 100 collects not only during actual storm or rainfall events but any time water travels over a surface rather than infiltrating into the soil or evaporating. Storm water 100 run-off flows from where it collects or where it is received into a catch basin and, in most instances, is eventually discharged to water bodies, such as creeks, streams, wetlands, ponds, rivers, estuaries, or the ocean. Accordingly, contaminants are desirably removed from the storm water 100 before being released into such bodies of water. Storm water 100 flows into a catch basin with insert 200 in accordance with one embodiment of the invention to remove contaminants. The insert includes a water-soluble water treatment additive, which dissolves and forms flocs with contaminants.

After contaminated storm water 100 has passed over the catch basin insert 200, storm water with water-soluble water treatment additive and flocculated contaminant 300 passes through a filter 400 positioned downstream from the catch basin insert 200. The filter 400 removes at least some of the flocculated contaminant from the storm water, resulting in storm water without contaminant 500 that may be released into rivers and streams. The filter 400 may be a radial filter, sand bed filter, settling tank, biological filter, water press, centrifuge, structural bulks, such as a detention vault, or proprietary devices, such as the Downstream Defender® by Hydro International (Portland, Me., USA) or StormFilter by Stormwater 360™ (Scarborough, Me., USA), or any other proprietary or non-proprietary downstream filtering means, including but not limited to Storm Water Management Practice (SMP) or Best Management Practice (BMP) filtering means.

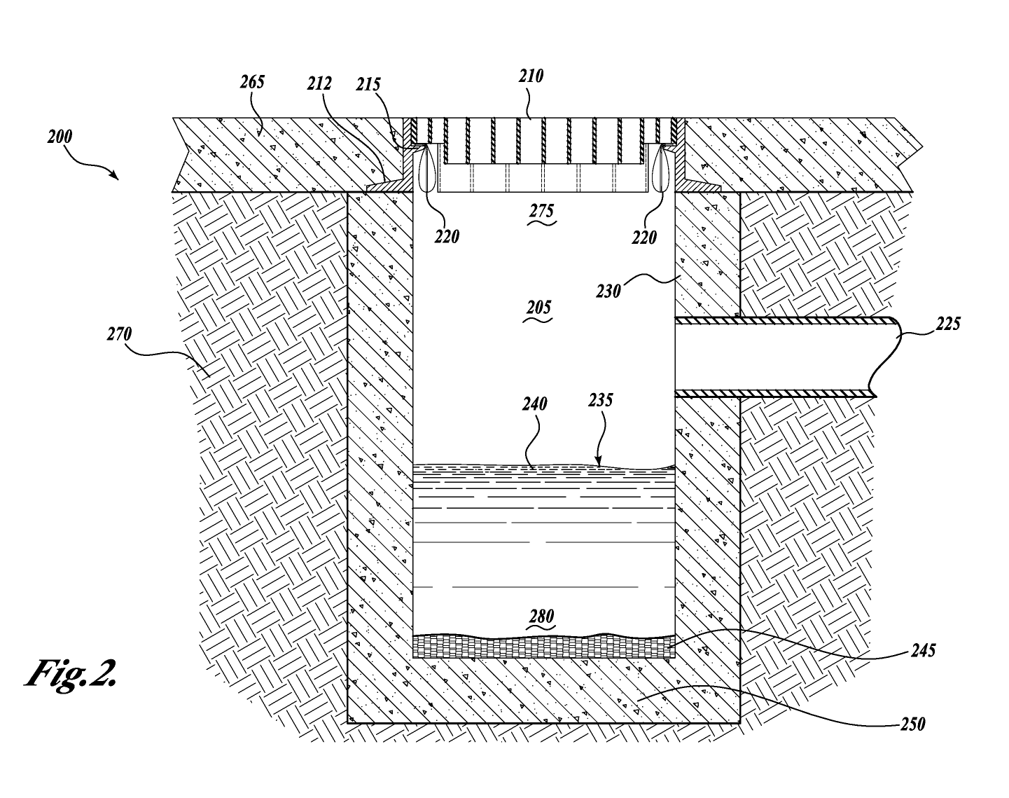

With reference to FIG. 2, one embodiment of a catch basin with insert 200 is illustrated. The catch basin 205 and insert 220 are separately described below. A catch basin 205, also termed a storm drain inlet or curb inlet, may be an excavated, diked or walled structure or combination of structures. Catch basins may serve as entry points into the storm drain system and are designed to remove pollutants from run-off before storm water is discharged into a receiving body of water.

Catch basin 205 may be an underground structure, typically made from concrete or a similar material, that collects storm water run-off and routes it through an underground pipe 225. The catch basin 205 may also be used between sections of a pipe system. The catch basin 205 has an upper section 275 and a lower section 280. The catch basin 205 includes four walls extending from the lower section 280 to the upper section 275 and a base at the lower section 275 in order to form a box with an opening at the top. The catch basin 205 is typically fitted with a grate 210 or other grilled device for catching large objects at the upper section 275. The grate 210 rests on a grate holder 212 seated on top of two or more catch basin walls 230 or formed by the walls themselves. The outlet pipe 225 passes through the wall 230 into the catch basin 205 and serves to drain the catch basin 205. The pipe 225 is positioned at an elevation that is below the lower portion of the insert 220, so that the insert 220 is prevented from continuously sitting in water. This prevents the water-soluble water treatment additive inside the insert 220 from dissolving. Alternatively, more than one outlet pipe may be connected to one or more basin walls. Typically, there is a storage volume called a sump 235 defined by the walls and base of the catch basin 205 and below the outlet pipe 225. The outlet pipe 225 is at an elevation above the base 250 of the basin so when the volume of storm water 240 in the catch basin 205 exceeds the sump 235 volume, the overflow drains through the pipe 225. Sediment and nonbuoyant materials 245 remain at the bottom of the sump 235 and can be removed periodically. The surface 265 around the catch basin 205 may be dirt, rocks, concrete and/or similar materials, as may be the material surrounding the catch basin walls below the surface 270.

Catch basin 205 may be used to gather storm water run-off from surfaces such as streets or parking lots. Catch basin 205 can be designed for locations where it catches run-off from all directions, e.g., in the middle of a parking lot, or for locations where run-off travels from a more focused direction, e.g., a curb-inlet configuration on the side of a street. Catch basin 205 is illustrated as having a rectangular configuration, but other embodiments can have other shapes, including round. Generally, dimensions of catch basin 205 can be about two to six feet wide, about two to six feet long, and about two to six feet high. The surface surrounding the top of the catch basin 205 can be sloped to carry water to the catch basin 205 so that the water falls through the grating 210 of the sides. An insert 220 is positioned below where the water falls into the catch basin 205, preferably on the sides where the water passes from the surface into the catch basin 205.

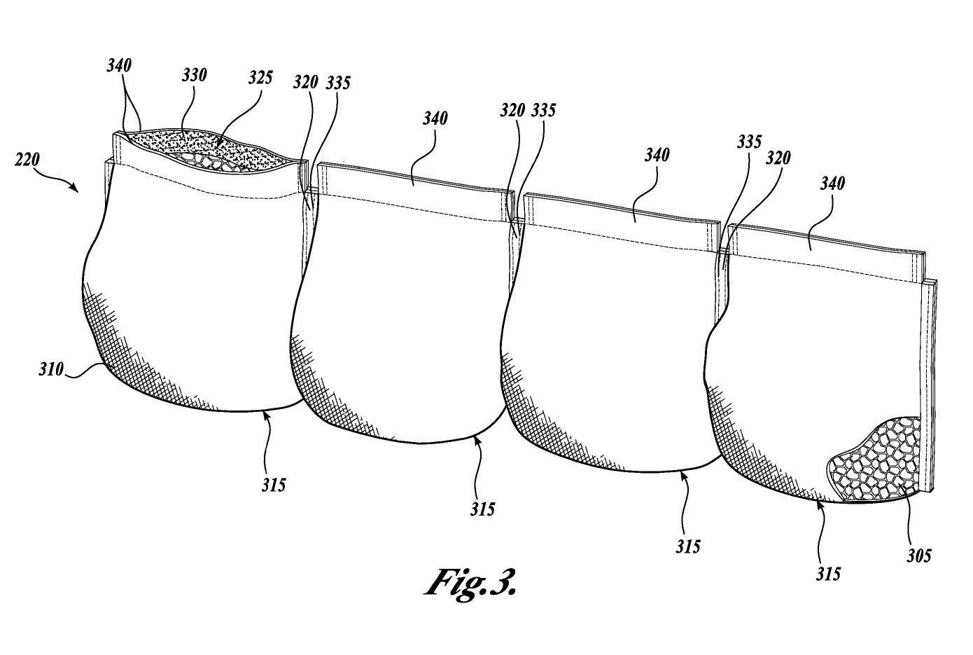

One embodiment of an insert 220 is shown in FIG. 3 and includes a water-soluble water treatment additive 305 contained within a porous, elongate outer shell 310. The porous shell 310 is segmented into individual pouches 315 along its length. In one embodiment, the shell 310 can be fabricated from an initially flat material that is folded longitudinally in the center to create two sides. The two sides are continuous along the length and are attached and/or bonded to one another perpendicularly with respect to the length to form the pouches 315. In one embodiment, adjacent pouches 315 are separated by a latitudinal length of shell material or strips 320. The strips 320 may include stitching 335 on both sides of the strips 320 that seals the sides of the pouches 315 and permits cutting the shell 310 between adjacent pouches 315 into a desired length without the additive 305 spilling out. Alternatively, the stitching may be replaced with any other bonding system, such as an adhesive, tape, staples, or heat seal. The strips 320 extend from the top of each pouch 315 to the bottom of the pouch 315. The stitching 335 may be in a color that highly contrasts with the color of the shell 310 (e.g., yellow stitching on a black shell). This contrast aids the installer in cutting the material. Due to the shape of the shell 310 and the strips 320 of shell material between pouches 315, the shell material may be distributed in long segments (e.g., on a roll). This allows the installing contractor to cut the length needed and also allows easy customization of each insert for individual catch basins.

The sides 340 of each pouch 315 form openings 325 along the top of the pouch 315. The individual pouches 315 may be closed by a resealable hook and loop fastener 330 or other means allowing for repeated opening and closing of the pouches 315. The top side sections 340 also create a rigid strip lengthwise.

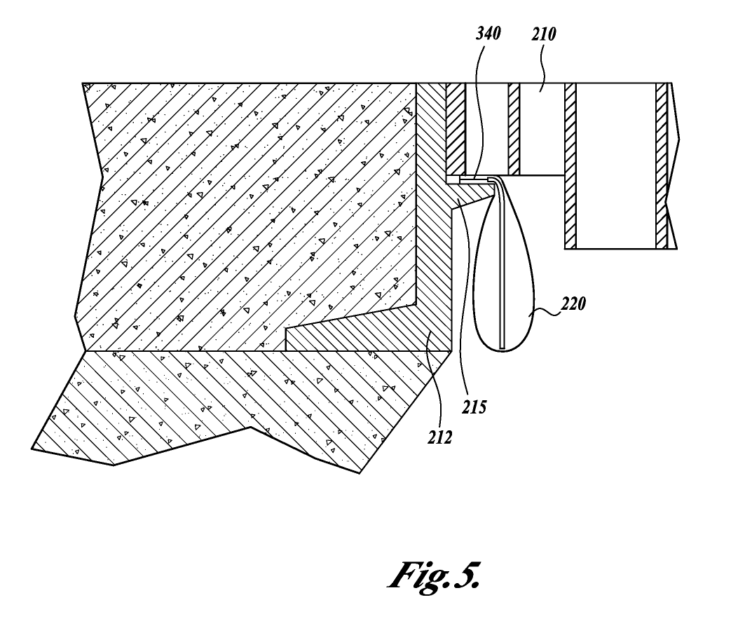

As shown in FIG. 5, the rigid top sections 340 may be retained or pinched between the bottom of the grate 210 and the top of the catch basin lip 215, thereby securing the insert 220 near the top of the catch basin 205. Additionally, the opening 325 (see FIG. 3) allows for the insertion or replacement of additive 305 inside the pouches 315 so the insert 220 can be periodically refilled to avoid discarding the outer shell 310.

The insert outer shell 310 is porous to allow water to enter and leave the shell 310 to contact the additive 305. The shell 310 should not have pores so large that they permit escape and rapid dissolution of additive 305. Typically, the diameter of pores is from 1 μm to 2000 μm, such as from 50 μm to 1000 μm, or from 100 μm to 800 μm. Representative examples of materials useful for making the porous shell 310 include natural and/or synthetic, woven or non-woven materials. Natural materials include animal and vegetable fibers. Exemplary animal fibers include silk, sheep wool, mohair, llama wool, alpaca, vicuña, camel hair, and horse hair. Exemplary vegetable fibers include cotton, jute, kapok, flax, hemp, Manila hemp, istle, ramie, sisal hemp, and Spanish moss. Exemplary synthetic materials include nylon, polyolefins, polypropylene, and polyester. Blends of any of the foregoing natural and/or synthetic fibers are also useful for making the porous shell 310.

An example of a commercially available woven fabric useful for making the porous shell 310 is a blend of about 65% polyester and about 35% cotton, which is referred to as a “poplin weave” and is supplied by MYBAG of Lynnwood, Wash., U.S.A. Another example of a useful synthetic knitted fabric is known by the designation Geoknit, which is manufactured by Syfilco Industrial Knitting, 320 Thames Road East, Exeter, Ontario, Canada.

Some embodiments of the porous shell 310 are stretchable. Some embodiments of the porous shell 310 can stretch up to 110%, up to 125%, or up to 150% of their unstretched length. Making the porous shell 310 from a stretchable material allows a portion of the additive 305 to be squeezed out of the shell 310 through its pores under certain conditions. Without intending to be bound by theory, it is hypothesized that at higher water flow rates, hydraulic pressure may cause the insert 220 to stretch. In this situation, less than fully dissolved additive 305 may be squeezed out of the insert 220 as pore size increases due to stretching. Further, hydraulic shear stress may cause the segmented insert 220 to articulate in an agitated manner. This agitation may cause momentary and localized increases in internal pressure in parts of the insert 220, resulting in squeezing of additional additive 305 through the porous shell 310. If the hydraulic pressure within the insert 220 rises to a level that might tear the shell 310, holes can be punched in the shell wall 310 to relieve the pressure.

As shown in FIG. 3, at least one insert pouch 315 contains a water-soluble water treatment additive 305. By way of example, water-soluble water treatment additive 305 can be in the form of a powder or gel. Each pouch 315 can include the same or different additive 305 as one or more of the other pouches 315. The pouches 315 can contain other additives besides the water-soluble water treatment additive 305. The embodiment of the catch basin insert 220 shown in FIG. 3 may be flexible. Flexibility is facilitated by the segmentation of the shell 310.

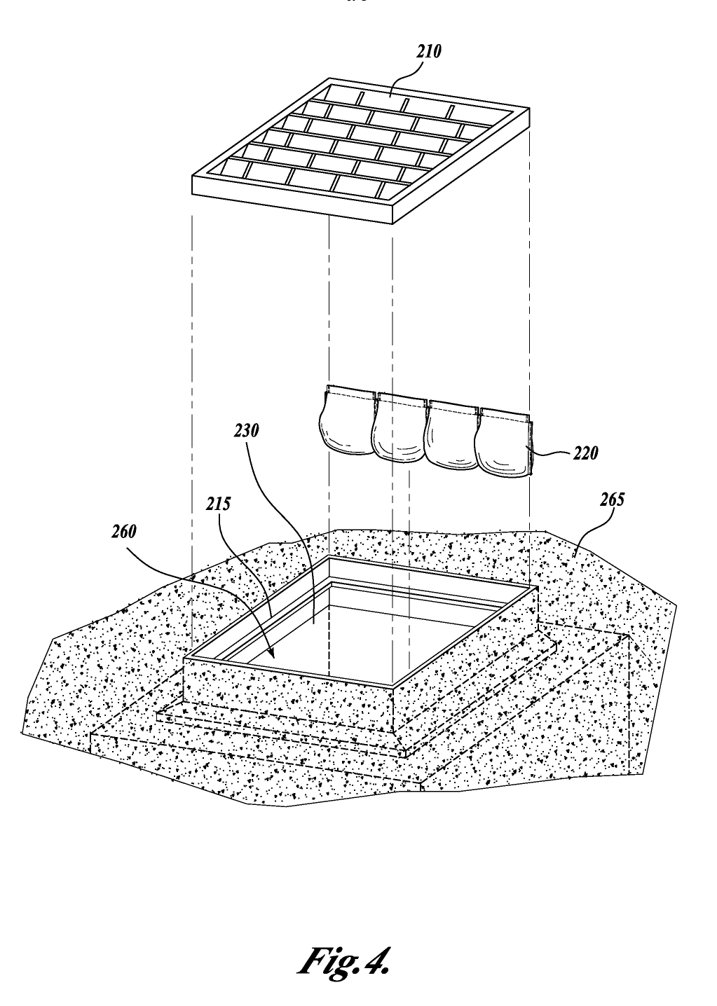

Referring to FIGS. 2, 4, and 5, the catch basin insert 220 is positioned in the path of storm water 100 entering the catch basin 205, preferably at a height above which the level of storm water 100 generally does not rise. Toward this end, the insert 220 is positioned above the outlet pipe 225 so that the bottom section of the insert 220 is above the upper rim of the outlet pipe 225. The catch basin insert 220 attaches to the catch basin 205 along the upper portion of the catch basin wall or walls 230. The insert 220 may span all or part of one or more walls 230. In one embodiment, shown in FIG. 4, the catch basin insert 220 is positioned in or adjacent the catch basin inlet 260. The area surrounding the catch basin inlet 260 may have sloped surfaces to direct the incoming water to the insert 220. With reference to FIG. 5, the grate holder 212 has the lip 215 extending horizontally inward from the sides to provide a platform on which the grate 210 may rest. Alternately, a lip may be formed from the catch basin walls 230 themselves. The top of the insert 340 is retained between two surfaces, such as the top of the lip 215 and the bottom of the grate 210. The insert 220 thereby appears as a “skirt” all around the inside perimeter of the catch basin 205. In other embodiments, the insert 220 is not held in place between two surfaces, but is positioned near the inlet 260 by other attachment means, such as by an adhesive or mechanical fasteners, such as nails, bolts, or screws. Additionally, the insert can be tied to the grate 210 or catch basin 205 with string or rope.

The position of the insert 220 at the upper section 275 of the catch basin 205 hanging from or next to one or more catch basin walls 230 facilitates the contact of storm water 100 entering the catch basin 205 with the insert 220. Preferably, some of the storm water 100 makes contact with the insert 220. The volume of storm water 100 that contacts the insert 220 dissolves a dose of additive 305 sufficient to flocculate a portion of contaminants in the incoming water, but the bulk of the incoming storm water 100 and associated debris may not pass through the insert 220. The insert 220 is positioned near the upper section 275 of the catch basin 205 and is not fully or partially submerged or immersed in the sump water 235 (which would result in premature dissolution of additive 305). Preferably, the insert 220 should be positioned in the catch basin 205 at a height above which the level of storm water 240 does not rise. This location prevents additive 305 from dissolving unnecessarily when not in contact with entering storm water 100. Placement of the insert 220 near the upper section 275 of the catch basin 205 is also advantageous for maintenance purposes as the insert 220 can be visually inspected without requiring lifting of the grate 210. When the insert 220 needs replacement, it can be removed and a new one installed without the need for confined-space entry of the catch basin 205.

With reference to FIGS. 1, 2 and 3, storm water 100 enters the catch basin 205 through the grate 210. Only a part of the storm water 100 entering the catch basin 205 is required to contact the insert 220. The storm water 100 penetrates the insert porous shell 310 and contacts additive 305, which begins to dissolve. A dose of the additive 305 dissolves into the storm water 100 and flows from the insert 220 with the water 100. If only a portion of the storm water 100 entering the catch basin contacts the insert 220, that portion re-mixes with the rest of the storm water after contacting the insert 220 and the dissolved water-soluble water treatment additive 305 is dispersed throughout the storm water 100. Once dissolved into the storm water 100, the water-soluble water treatment additive 305 flocculates by forming insoluble complexes with contaminants in the storm water 100. Storm water with water-soluble water treatment additive and flocculated contaminant may collect and be stored in the sump 235 (FIG. 2), allowing sediments and debris 245 to settle out. When the storm water volume 240 exceeds the sump volume 235, storm water with water-soluble water treatment additive and flocculated contaminant 300 will flow out of the catch basin 205 through the outlet drain 225. Alternately, or in addition to being separated from the storm water 300 by a downstream filter 400, flocculated contaminant may settle to the sump 235 at the lower end of the catch basin 205 and be removed during regular maintenance of the catch basin.

Water-soluble water treatment additive 305 may bind non-covalently to one or more types of contaminants in water to form water-insoluble additive/contaminant complexes. Water-soluble water treatment additive 305 may be used, for example, in a dry form (e.g., powder) or in the form of a gel or paste. The choice of additive 305 involves consideration of such factors as the identity of the principal contaminant(s) in the water to be treated, and the affinity of the additive 305 for the principal contaminant(s). Examples of contaminants typically found in storm water include bacterium, soil particles, metal ions, phosphates, orthophosphates, and oil, such as lubricating or fuel oil. By way of non-limiting example, additives 305 useful in the practice of the present invention include chitosan salts. Again by way of example, additive or additives 305 useful in the practice of the present embodiments include one or a blend of cationic or anionic forms of N-halochitosans, gums, starches, and polyacrylamide (including copolymers of acrylic acid and acrylamide, and copolymers of acrylamide and quaternary ammonium compounds). Mixtures of different individual additives 305 can also be used, such as a mixture of a chitosan salt and an N-halochitosan or a mixture of any two or more of the additives described above. Some inserts 220 may include both anionic and cationic additives 305. Inserts 220 may comprise one or more of the above-mentioned additives. Further additives useful as additive 305 are described in U.S. Pat. No. 6,749,748, issued on Jun. 15, 2004, expressly incorporated herein by reference in its entirety.

With respect to solubility in water, under normal operating conditions additives 305 should dissolve at a rate that permits a reasonable working lifetime. Thus, for example, some embodiments of insert 220 can treat 500,000 gallons of storm water before all of the additive 305 is dissolved. Chitosan salts useful as flocculants in the practice of the invention typically have a molecular weight in the range of from 20,000 Daltons to two million Daltons, such as from 50,000 Daltons to one million Daltons, or such as from 100,000 Daltons to 900,000 Daltons. Chitosan salts useful in the practice of the invention typically have a percentage deacetylation of from 50% to 100%, such as from 60% to 95% or from 70% to 90%. Some chitosan salts useful in the practice of the embodiments are a salt of chitosan with a C₁ to C₁₈ mono- or polycarboxylic acid, such as chitosan acetate or chitosan lactate. By way of non-limiting example, chitosan salts useful in the practice of the embodiments include chitosan glutamate, chitosan hydrochloride, chitosan succinate, chitosan fumarate, chitosan adipate, chitosan glycolate, chitosan tartrate, chitosan formate, chitosan malate, and chitosan citrate.

Other useful additives include anionic or cationic forms of any of the following compounds: N-halochitosans, gums, starches, and polyacrylamides. Exemplary N-halochitosans useful in the practice of the embodiments are polymers that include about 1% to about 35% 2-deoxy-2-acetamidoglucose monomeric units, about 1% to 90% 2-deoxy-2-aminoglucose monomeric units, and about 8% to 98% 2-deoxy-2-haloaminoglucose monomeric units, wherein the haloamino group is chloroamino or bromoamino or iodoamino. Exemplary cationic gums include polysaccharide gums, such as cationic guar, which is neutral guar that has been chemically modified to contain quaternary amines. Anionic polysaccharides (both naturally occurring and chemically produced through chemical derivitization of neutral polysaccharides) are useful as additives 305. Examples of anionic polysaccharides include sodium or potassium alginate, carrageenans, carboxymethylcellulose, carboxymethylchitosan, locust bean gum, dextran sulfate, succinylated starch, succinylated chitosan, and pectins. Inorganic anionic additives 305 include polyphosphates, such as hexametaphosphate.

The contaminant flocculated by the water-soluble water treatment additive 305 and filtered from the storm water 100 may be a bacterium, including but not limited to fecal coliform, other coliforms, cryptosporidium or Guardia. Alternately, or in addition to bacterium, the contaminant may be one or more of the following: Total Suspended Solids (TSS), including soil particles, organic materials, and/or other solids; metals (suspended or dissolved); nutrients including phosphates, orthophosphates, nitrogen and nitrates; oil; hydrocarbons; and detergents. The additive 305 may flocculate one type of contaminant or multiple types.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system for removing a contaminant from storm water, comprising:
(a) a catch basin for receiving storm water; and
(b) a catch basin insert positioned in the path of storm water entering the catch basin and at a height in the catch basin above which the level of storm water does not rise in the catch basin, wherein the insert comprises a water-soluble water treatment additive contained within a porous shell.

2. The system of claim 1, further comprising a filter positioned downstream from the insert for filtering a contaminant from the storm water flocculated by interaction with the water-soluble water treatment additive.

3. The system of claim 1, wherein the catch basin comprises a grate supported by the upper portions of one or more catch basin walls, and an outlet drain in the lower portion of the catch basin.

4. The system of claim 3, wherein the insert attaches to the catch basin at the upper portion of one or more catch basin walls.

5. The system of claim 4, wherein the catch basin has a lip extending horizontally from the top of one or more catch basin walls, and wherein the insert has a longitudinal edge that is retained between the grate and the catch basin lip.

6. The system of claim 1, wherein the catch basin is located in a parking lot, curb inlet, drainage area, or channel drain.

7. The system of claim 1, wherein the filter is a radial filter.

8. The system of claim 1, wherein the filter is a sand bed filter.

9. The system of claim 1, wherein the contaminant comprises a bacterium.

10. The system of claim 1, wherein the contaminant comprises fecal coliform.

11. The system of claim 1, wherein the contaminant comprises soil particles, metals, phosphates, orthophosphates, or oil.

12. A method for flocculating a contaminant in storm water, comprising contacting storm water with an insert at or adjacent to a catch basin, wherein the insert is positioned in the path of storm water entering the catch basin and at a height in the catch basin above which the level of storm water does not rise in the catch basin, and wherein the insert comprises a water-soluble water treatment additive contained within a porous shell, and wherein a dose of the water-soluble water treatment additive is dissolved in the storm water and binds to a contaminant in the storm water to provide flocculated contaminant.

13. The method of claim 11, wherein the insert comprises a chitosan salt.

14. The method of claim 11, wherein the insert comprises a water-soluble cationic flocculant.

15. The method of claim 11, wherein the insert comprises a chitosan salt, a cationic N-halochitosan, a cationic gum, a cationic starch, a cationic polyacrylamide, or a combination thereof.

16. An insert for removing a contaminant from storm water, comprising a porous, elongate shell comprising a plurality of segmented pouches along the length of the shell, at least two or more pouches containing a water-soluble water treatment additive, wherein two adjacent pouches are separated by a strip of shell material to permit cutting the shell between pouches into a desired length without releasing the water-soluble water treatment additive from the pouches.

17. The insert of claim 16, comprising high contrast stitching defining the latitudinal edges of each pouch segment.

18. The insert of claim 16, wherein the insert comprises a chitosan salt.

19. The insert of claim 16, wherein the material from which the insert is made is stretchable.

20. The insert of claim 16, wherein the strip of shell material is bordered by two lines of stitching to separate the two adjacent pouches and leave a space between the lines of stitching where the insert may be cut.

21. The insert of claim 16, wherein the strip of shell material extends from the top of the pouches to the bottom of the pouches.

22. The insert of claim 16, wherein the insert has two continuous sides that are attached to one another perpendicularly with respect to the length of the insert to form the pouches.

23. An insert for removing a contaminant from storm water, comprising a porous, elongate shell comprising a plurality of segmented pouches along the length of the shell, at least one pouch containing a water-soluble water treatment additive, wherein one or more pouches contain an opening closed by a resealable hook and loop fastener.
